(19) United States
(12) Patent Application Publication
(10) Pub. No.: US 2007/0114789 A1
(43) Pub. Date: May 24, 2007

(54) Printable laminate, printable laminate kit and method for producing the same

(75) Inventor: John Morrish, Barnet (GB)

Correspondence Address: NIXON & VANDERHYE, PC, 901 NORTH GLEBE ROAD, 11TH FLOOR, ARLINGTON, VA, 22203, US

(73) Assignees: Peter Geoffrey Alan MORRISH, Newtown (GB); Priscilla Dorothy MORRISH, Newtown (GB); Mark Peter MORRISH, Newtown (GB); Kenneth George MORRISH, Newtown (GB); Gerald David MORRISH, Newtown (GB)

(21) Appl. No.: 11/598,233

(22) Filed: Nov. 13, 2006

(30) Foreign Application Priority Data
Nov. 16, 2005 (GB) 0523348.1
Jan. 25, 2006 (GB) 0601496.3

(51) Int. Cl. B42D 15/00

(52) U.S. Cl. 283/107

(57) ABSTRACT

A printable laminate, kit and methods for making and modifying the same, the printable laminate comprising a top sheet laminated with a backing sheet. The top sheet is printable and cut by at least one intermittent cut line to define a corresponding number of removable elements, and a waste element. The intermittent cut line includes a plurality of bridging portions which connect the, or each, removable element to the waste element. Removal of a removable element from the backing sheet and waste element is typically achieved by lifting of a side or corner of the removable element and breaking the bridging portions in series along the intermittent cut line.

### BACKGROUND TO THE INVENTION

The present invention relates to printable laminates. More particularly, but not exclusively, it relates to printable laminates comprising removable elements. Such removable elements may be used as an insert element to customise an item, such as a drinks coaster, key fob, name tag or the like, by insertion into a pocket within that item such that text and/or an image printed on the insert element is visible through a transparent portion of the item. Alternatively, the removable elements may be used to form three-dimensional novelty items such as hats, containers, or the like by folding or other means. As a further alternative, the removable elements may be used as stationery items such as tickets, greetings cards, place cards or the like, or for insertion into stationery articles such as calendars, notebooks, diaries or the like.

It may often be desirable to produce relatively small numbers of an element for use as a novelty item, stationery item, or as an insert element for a customisable item or stationery article (e.g. tens, hundreds, or even a single article). For example, such an item may be a marketing item for a small company, a souvenir item for a local event, or a personalised item for a conference, etc. In such cases it may be desirable that an element be customised with text and/or an image using readily-available printing equipment such as an ink-jet or laser printer.

Known techniques for producing elements for use as insert elements, novelty items or stationery items are adapted for large production volumes. Such known techniques typically use specialised printing and/or cutting equipment. In particular, where a desired element is a non-standard shape or size, such that it cannot be accommodated by standard printing equipment, the element may be produced by printing the desired text and/or image onto standard size paper or card, or a roll of paper or card, and then cutting it to the required shape using a specialist tool. Alternatively, the paper or card may be cut to the required shape or size and subsequently printed using specialised printing equipment. Such techniques are not easily adapted to small production volumes, or small elements, and it is therefore expensive per item to produce a relatively small number of elements.

### SUMMARY OF THE INVENTION

The present invention seeks to avoid, ameliorate, or even overcome at least one of the above problems.

One approach considered by the present inventor has been to provide a printable laminate of a top sheet and a backing sheet, the top sheet being cut to define a plurality of removable elements and a waste element. In use, the top sheet is printable, so that the removable elements (and also the waste element, if desired) are printed. After printing, the removable elements can be removed and used to customise an item, or to produce a novelty item or a stationery item. The advantage of this approach is that a small number of removable elements can be printed (e.g. one sheet of the printable laminate) using a conventional printing apparatus, such as a photocopier or a printer controlled by computer.

However, it has been found that such printable laminates suffer from a problem that all or part of a removable element has a tendency to separate from the waste element when the printable laminated is printed. This problem is particularly noticeable when the printable laminate is guided around rollers in the printing apparatus. The result can be detachment of one or more removable elements during printing, with corresponding damage to the printer. Other results can be masking or shadowing of the printed image in places on the printable laminate, due to lift-off of parts of one or more removable element during printing.

In a general aspect, the present invention provides bridging portions between the removable element and the waste element.

These bridging portions can assist in preventing unwanted detachment of the removable element from the waste element, e.g. during printing or other processing.

In a first preferred aspect, the present invention provides a printable laminate comprising a top sheet laminated with, and adhered to, a backing sheet, the top sheet being printable and having a removable element and a waste element, said removable element and waste element being divided by an intermittent cut line extending between said waste element and said removable element, to define the perimeter of said removable element, the intermittent cut line having a plurality of bridging portions connecting said removable element and waste element, the removable element being separable from the backing sheet and waste element by breakage of the bridging portions.

Some preferred and/or optional features of the first aspect are set out below. These may be combined in any combination, or may be applied separately, unless the context demands otherwise. These features are also applicable to the other aspects of the invention.

Preferably, the top sheet is laminated with the backing sheet so as to be peelable therefrom. In this way, removal of the or each removable element will typically be achieved by lifting of a side or corner of the removable element and breaking the bridging portions in series along the intermittent cut line.

Preferably, when the removable element is separated from the backing sheet, the removable element is substantially non-adhesive. This allows the removable element to be used more easily as an insert element for customising an item, or for use as, for example, a novelty item or stationery item. Similarly, when the removable element is separated from the backing sheet, the exposed face of the backing sheet is preferably substantially non-adhesive. However, it is also possible that the backing sheet is in fact adhesive. For example, the “backing sheet” may in fact be an adhesive sheet (e.g. as used in self-adhesive printable label sheets).

Preferably, the backing sheet and the top sheet are substantially coterminous. In this way, the backing sheet and the top sheet will occupy the same footprint. This is advantageous in a printing operation, since the thickness of the laminate will be substantially uniform along the length and width of the laminate.

Preferably, the top sheet has an area density of at least 120 gsm (grams per square metre). This is a relatively high area density, representing heavy paper or card. Such material is preferred since it is relatively stiff and suitable for insertion into pockets of customisable items, or for creating a novelty or stationery item, as will be described in greater detail below. However, the stiffness of the top sheet also exacerbates the problem of the removable elements lifting from the waste element during printing. The area density of the top sheet may be 80 gsm or more, 90 gsm or more, 110 gsm or more, 130 gsm or more, 140 gsm or more, 150 gsm or more, 160 gsm or more, 170 gsm or more, 180 gsm or more, 190 gsm or more 200 gsm or more, 210 gsm or more, or about 215 gsm.

Preferably, each bridging portion has a width of 1 mm or less. This provides a bridging portion of suitable mechanical integrity to avoid unwanted failure, but provides a small enough feature so that the torn edges of the bridging portions after removal of the removable element are not detrimentally noticeable. The width of the bridging portions may be 0.9 mm or less, 0.8 mm or less, 0.7 mm or less, 0.6 mm or less, 0.5 mm or less, 0.4 mm or less, 0.3 mm or less. Preferably the width of the bridging portions is 0.25 mm or more.

The bridging portions may be spaced apart on said cut line by 15 mm or less, on average for said cut line. This spacing distance may more preferably be 14 mm or less, 13 mm or less, 12 mm or less, 11 mm or less, 10 mm or less, 9 mm or less, 8 mm or less, 7 mm or less or 6 mm or less. Preferably, the spacing distance is 5 mm or more.

The bridging portions may be spaced along the entire length of the said cut line. Alternatively, the bridging portions may be spaced along part of the cut line.

Preferably, each removable element is blank. Thus, the printable laminate, as an item of commerce, is intended to be provided to the user in unprinted form, or in only partially printed form. The user is then able to apply desired text and/or images to the removable element by printing.

Preferably, a plurality of removable elements are arrayed in a matrix in said top sheet. The matrix may be a rectilinear matrix. The matrix may be any suitable array, for example 5 by 10. There may be 16 or more removable elements formed in the top sheet, more preferably 20 or more, 30 or more or 40 or more.

Preferably, the removable element is for insertion into a customisable item, the customisable item being selected from one of: a key fob, a drinks coaster, name tag, ruler, pen, mouse mat, table mat, clock, letter opener, memo holder, pen pot, badge, paper stand, drinks container such as a travel mug, fridge magnet and calendar case.

Preferably, the waste element abuts against the removable element at its perimeter.

In a preferred embodiment, the or each removable element is in a flat form when laminated with the backing sheet and being formable into a predetermined body form after removal from the backing sheet and waste element, and has at least one concave or inward cut feature at its perimeter or a cut feature wholly or partly disposed within its perimeter, said cut feature defining first and second cut surfaces that move relative to each other to accommodate the shape change from the flat form to the body form.

In this way, the invention allows a user to personalise the pre-cut removable element of the top sheet as required before removal from the backing sheet and waste element and then remove the removable element from the backing sheet and waste element to form the removable element into the required body form.

In this way, the overall cost of preparing relatively small numbers of bespoke printed body form articles can be significantly reduced.

Preferably, the body form has concave or convex cross-sections in each of two or more orthogonal directions.

Preferably, the at least one cut feature forms all or part of a cut pattern in the removable element and the cut pattern opens to accommodate the shape change from the flat form to the body form.

The cut feature may be at least one slit that is closed in the flat form and open in the body form. Most preferably, the cut feature is a pattern of spiral slits interposed between a central portion and a rim portion, the central portion being moveable out of plane from the rim portion by opening of the spiral slits.

The removable element may include attachment formations that cooperate to attach to each other in the body form to retain the removable element in the body form. In this way, the removable element may be locked into the body form. There may be a range of attachment formations that are present for use on the removable element. Preferably, the body form of the removable element is adjustable in size by adjusting the selection of the attachment formations used to retain the removable element in the body form. The attachment formations may include, for example, at least one tab and/or at least one slot.

Preferably, the body form of the article is selected from one of: a hat, a cap, a bib, a mask and a children's party product.

In an alternative preferred embodiment, the removable element is formable into a predetermined container form having a base and walls, opposing walls being spaced apart from each other.

In this way, the invention may be applied specifically to the case where the body form of the removable element is a container. Customisation of such containers (e.g. a box), particularly at small scale, is difficult to achieve using conventional techniques.

Preferably, the removable element includes a portion shaped to be an integral lid of the container.

Alternatively or additionally, the top sheet further includes a second removable element, the second removable element being shaped to be a separable lid for the container.

When the removable element is formable into a predetermined body form, the body form may be achieved in part by folding of the removable element. This folding may be achieved using pre-formed lines of weakness in the removable element. Preferably, the lines of weakness are scored or perforated lines. In this way, the lines of weakness may be formed into the removable element as part of the process of manufacturing the laminate, and before printing of the desired images onto the top sheet.

In another preferred embodiment, the removable element has a shape to allow it, once removed from the backing sheet and the waste element, to be inserted into the binding of an article of stationery having a plurality of pages bound by a binding that extends through apertures in the pages, the apertures being guided around the binding when the pages are turned.

In this way, a standard stationery article, such as a desktop calendar, may be customised by the insertion of the removable element. The removable element may be inserted at the top of the stationery article, i.e. as a cover sheet. However, it is preferred that the removable element itself is covered during use of the stationery article. A cover element such as a transparent or translucent sheet, or a sheet (formed, e.g. from stiffer material than the removable element) having a window through it, may be bound with the other leaves in the article for this purpose. In this way, the removable element is protected by the cover sheet, whilst still being (at least partially) visible through it.

Preferably, the removable element includes open apertures for allowing the removable element to be inserted into the binding.

Preferably, the open apertures are separated from the removable element by part of a cut line that does not include bridging portions.

Preferably, the open apertures have fingers extending between them, the fingers being for insertion between elements of the binding. Furthermore, the fingers preferably have barbs formed at their free ends for retaining the removable element in the binding. These barbs typically do not particularly hinder the insertion of the removable element into the binding but they assist in preventing the removal of the removable element from the binding.

Preferably, the insertion element has at least eight, preferably twelve or more, apertures for engagement with the binding.

Preferably, the article of stationery is selected from one of: a calendar, a notebook, and a diary.

In a further preferred aspect, the present invention provides a method for producing a printable laminate according to the first aspect, including any combination of the optional or preferred features thereof, the method including the step of forming the intermittent cut line in the top sheet using a kiss-cutting tool with a corresponding intermittent cutting edge.

In another preferred aspect, the present invention provides a kit including one or more printable laminates according to the first aspect, including any combination of the optional or preferred features thereof, the kit further including instructions for printing onto the top sheet of the printable laminate before removal of the removable element from the backing sheet and waste element.

In this way, it is envisaged that the printable laminates may be sold as a kit, so that a user can create several customised items, novelty items, or stationery items according to need.

Preferably the kit further includes a software product for managing the printing of the printable laminate.

Preferably, the printing step prints at least part of the customising image onto the waste element. In this way, it can be ensured that the image extends substantially to the perimeter of the removable shaped element.

In another preferred aspect, the present invention provides a kit including a customisable item having a pocket for receiving a removable element, and a printable laminate according to the first aspect, including any combination of the optional or preferred features thereof, wherein each removable element is insertable into the pocket of the customisable item to customise said item.

Preferably, the kit includes a plurality of customisable items and a corresponding number of removable elements in one or more printable laminates.

In another preferred aspect, the present invention provides a kit including an article of stationery having a plurality of pages bound by a binding that extends through apertures in the pages, the apertures being guided around the binding when the pages are turned, and a printable laminate for this purpose as set out above, including any combination of optional or preferred features thereof, wherein the removable element of the printable laminate is for insertion into the binding of said article after binding of said pages.

The kit allows a user to personalise the insertion element as required and then fit it to the stationery article to provide a personalised stationery article.

Preferably, the kit includes a plurality of articles of stationery and a corresponding number of removable elements in one or more printable laminates. In this way, a user may modify a set of such articles as desired, either with the same design or with different designs such as personalised designs.

Preferably, the binding includes looped binding elements extending through the apertures. Such loops allow the pages to be turned so as to expose the entirety of the next page. Typically, the binding is a comb or spiral binding.

Preferably, the apertures in the pages of the article of stationery are closed holes. This allows for reliable securing of the pages in the article.

Preferably, the kit further includes an insertion tool having a shape corresponding to spaces between elements of the binding. The insertion tool may be comb shaped, the teeth of the comb being for inserting corresponding fingers of the removable element into the binding. Further, the insertion tool may be (or at least the teeth of the insertion tool may be) stiffer than the insertion element in order to allow the easy insertion of the removable element into the binding.

It may be preferred to personalise the article of stationery, e.g. with images and/or information relating to a business (as a marketing device), a particular person (as a greeting) or a particular place (as a souvenir).

In another preferred aspect, the present invention provides a method of customising a printable laminate according to the first aspect, including any combination of the optional or preferred features thereof, the method including the steps of:
printing text and/or an image on to at least one removable element; and
separating said at least one removable element from the waste element and backing sheet.

Preferably, the printing step prints at least part of the customising image onto the waste element. In this way, it can be ensured that the image extends substantially to the perimeter of the removable shaped element. The printing step is preferably carried out using readily-available printing equipment such as an ink-jet or laser printer, or a photocopier.

In another preferred aspect, the present invention provides a method of customising a customisable item, the customisable item having a pocket for inserting a removable element of a printable laminate according to the first aspect, including any combination of the optional or preferred features thereof, the method including the steps of:
separating the removable element from the waste element and backing sheet by breaking the bridging portions; and
inserting the removable element into the customisable item.

In another preferred aspect, the present invention provides a method of customising an article of stationery using a printable laminate according to the first aspect, including any combination of the optional or preferred features thereof, wherein the article of stationery includes a plurality of pages bound by a binding that extends through apertures in the pages, the apertures being guided around the binding when the pages are turned, the method including the steps of:
separating the removable element from the waste element and backing sheet by breaking the bridging portions; and
inserting the removable element into the binding of the article of stationery.

Preferably, the method aspects of the invention further include the step of printing text and/or an image on to the removable element before the removable element is separated from the waste element and backing sheet.

Thus, the process of forming the shape of the removable element and/or any apertures in the removable element preferably does not give rise to the production of waste material that might clog up the cutting machine. Instead, the waste material is retained, in one piece, on the backing sheet.

### BRIEF DESCRIPTION OF THE DRAWINGS

Preferred embodiments of the invention will now be described, by way of example, with reference to the accompanying drawings, in which:

FIG. 1 is a plan view of a blank printable laminate according to an embodiment of the invention, with an enlarged view of a detail of the printable laminate;

FIG. 2 is a plan view of a portion of a printed printable laminate according to an embodiment of the invention;

FIG. 3 is a plan view of a portion of a printed printable laminate according to an embodiment of the invention, after the separation of a removable element from the laminate;

FIG. 4 shows a plan view of a customised item according to an embodiment of the invention;

FIG. 5 shows an end view of the customised item of FIG. 4.

FIG. 6 shows an embodiment of the invention before printing and folding into a body form;

FIG. 7 shows an embodiment of the invention before printing and folding into a body form;

FIG. 8 shows an embodiment of the invention before printing and forming into a body form;

FIG. 9 is a schematic view of a desktop calendar for use with an embodiment of the invention;

FIG. 10 is a perspective view of a blank printable laminate according to an embodiment of the invention;

FIGS. 11 and 12 are perspective views of the printable laminate of FIG. 10 after printing.

FIG. 13 is a schematic enlarged plan view of part of a removable element according to an embodiment of the invention.

### DETAILED DESCRIPTION OF THE PREFERRED EMBODIMENTS

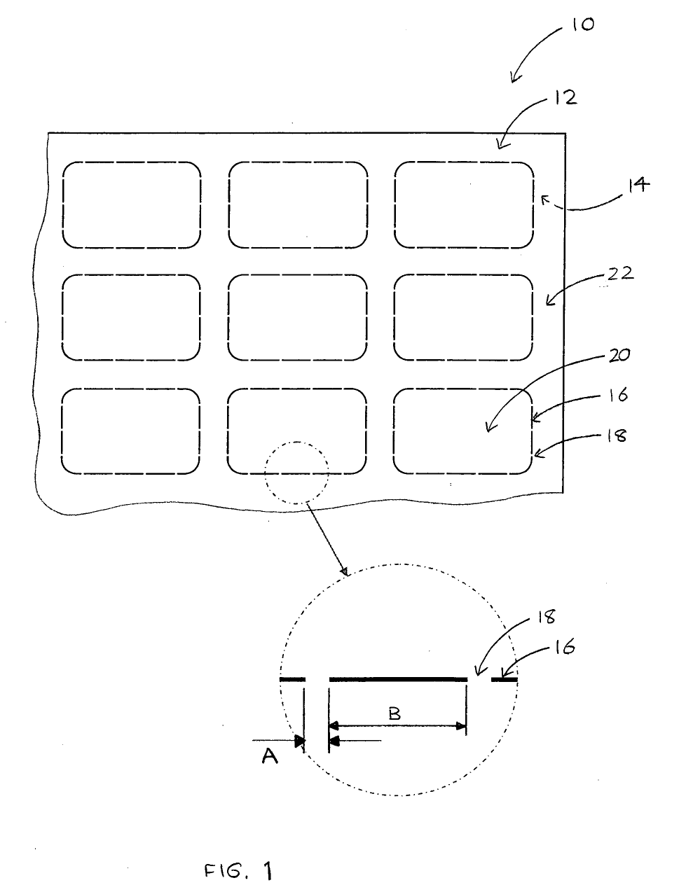

The printable laminate 10 in the embodiments shown in FIGS. 1 to 13 is formed from a “dry-peel” laminate, such as a known dry-peel laminate from companies such as Avery™, or other stationery supply companies. The printable laminate 10 comprises a top sheet 12 bonded with a backing sheet 14, which may be separated, or peeled, apart so that the exposed surfaces of both the top sheet 12 and backing sheet 14 are substantially non-adhesive, or not sticky or tacky to the touch. In some embodiments, the backing sheet may be adhesive after peeling, but the top sheet is preferably not adhesive after peeling.

The printable laminate 10 is preferably a standard ISO paper size, such as A4 (210 mm×297 mm) or other standard paper size, such as US letter size (8.5″×11″). This allows the printing operation to be carried out on readily-available printing equipment such as a laser or ink-jet printer, or a photocopier.

The top sheet 12 of the printable laminate 10 is typically a paper- or card-based sheet, preferably with a weight per unit area of at least 120 gsm (grams per square metre) or more. The most preferred embodiment uses a weight per unit area of about 215 gsm. Thus, the top sheet 12, when separated from the backing sheet 14, is relatively stiff and substantial when compared to, for example, a sheet of standard photocopy/printing paper with a typical weight per unit area of 80 gsm.

The backing sheet 14 of the printable laminate 10 is typically of lower weight per unit area than the top sheet 12. The surface of the backing sheet 14 adhered to the top sheet 12 may be smooth and/or shiny to assist the peeling of the top sheet 12 from the backing sheet 14.

In the embodiments shown in FIGS. 1 to 13, the top sheet 12 of the printable laminate 10 is cut by a number of intermittent cut lines 16 to define the perimeters of a corresponding number of removable elements 20. Thus, the top sheet 12 comprises a number of removable elements 20 and a waste element 22.

In the embodiments shown in FIGS. 1 to 3, the removable elements 20 are arrayed in a regular matrix. This arrangement maximises the number of removable elements 20 in the printable laminate 10, whilst ensuring the spatial separation of the removable elements. The regular arrangement of the removable elements also helps simplify the process of arranging the position of text and/or images to be printed on the removable elements.

Each cut line includes a plurality of bridging portions 18 corresponding to the uncut portions of the perimeter of the corresponding removable element. The bridging portions 18 serve to retain each removable element 20 with respect to the waste element 22 until it is required by a user to detach the removable elements from the waste element.

The bridging portions 18 and cut line 16 are shown in more detail in the expanded view of FIG. 1. The width, A, of the bridging portions 18 is typically 1 mm or less, preferably 0.75 mm or less but 0.25 mm or more, more preferably around 0.5 mm. The width of the bridging portions 18 is chosen so that each removable element 20 may be easily removed from the waste element 22 and backing sheet 14 by breakage of the bridging portions 18 by a user. Further, it is desirable that the broken remains of the bridging portions 18 on the removable element 20, at least, are substantially not visible, or obvious, to the naked eye.

It is desirable that the bridging portions 18 are spaced close enough together to ensure that each removable element 20 is firmly connected to the waste element 22 and retained by the backing sheet 14, but far enough apart so that each removable element 20 may be easily removed from the waste element 22 and backing sheet 14. On average for each cut line, the bridging portions 18 are typically spaced apart on that cut line by a distance B of 15 mm or less, preferably 10 mm or less, and more preferably around 9 mm.

The intermittent cut line 16 is formed using a modification of a known “kiss-cutting” operation in which the top sheet 12 is cut, but the backing sheet 14 is not. The backing sheet 14 thus retains the removable elements 20 and waste element 22 in their relative positions. The kiss-cutting operation is performed using a tool (not shown) with an intermittent cutting edge, such that the non-cutting portions of the cutting edge correspond to the bridging portions 18. The person skilled in the art of kiss-cutting will readily understand, given the desired shape of the removable element 20 and the dimensions and location of the bridging portions, how to form an appropriate tool, and carry out the kiss-cutting operation.

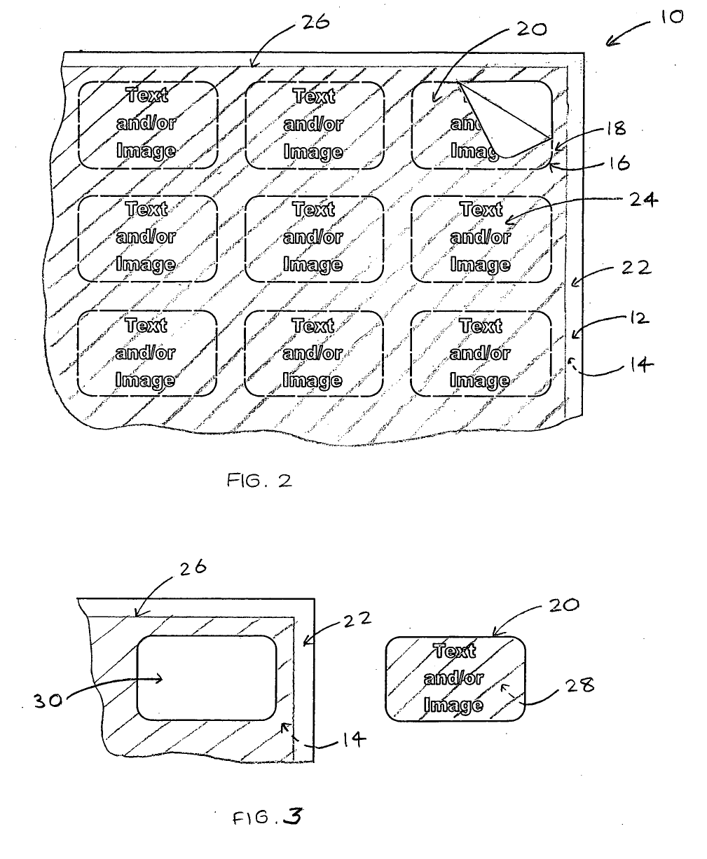

FIG. 2 shows a portion of a printed printable laminate 10. Text and/or images 24, as desired, are printed onto the top sheet so that at least the removable elements are printed. As shown in the drawing, a large printing region 26 (shown cross-hatched) may be printed so that at least part of the waste element 22 and the removable elements are printed. This may simplify the printing layout and may help to ensure that each removable element 20 is wholly covered by, for example, a background colour or pattern, where desired.

Because the top sheet 12 of the printable laminate is typically 160 gsm or more, it is inherently stiff and resistant to flexing. During the printing process, the printable laminate 10 must usually flex in order to pass around rollers within the printing equipment. The bridging portions 10 serve to retain the removable elements 20 on the backing sheet 14 because of the connection they provide between the removable elements 20 and the waste element 22, and thus serve to ensure that the removable elements 20 flex to the same degree as the backing sheet 14 and waste element 22. In this way, the lifting of corners and/or edges of the removable elements 20 away from the backing sheet 14 is avoided, or reduced. Thus shadowing of portions of the top sheet by lifted corners and/or edges, which can make the printed result patchy, particularly around the periphery of a removable element 20, is avoided, or reduced. Further, risk of corners and/or edges of a removable element 20 becoming caught during the printing process so that the removable element 20 is completely separated from the backing sheet is avoided, or reduced. Such a separation may cause the removable element 20 to become lodged within the printing equipment so that the printing process is interrupted, or the printing equipment is damaged.

FIG. 2 shows a removable element 20 (shown top right in drawing) that is partially separated, or peeled, from the backing sheet 14 and waste element 22, by the breakage of some of the bridging portions 18. The same removable element 20 is shown in FIG. 3 fully separated from the backing sheet 14 and waste element 22. All the bridging portions 18 along the cut line 16 around the perimeter of the removable element 20 have been broken. As noted above, the remains of the broken bridging portions 18 are substantially not visible and/or not obvious, to the naked eye.

It is a feature of the dry-peel laminate that the newly-exposed portion of the removable element 28 and the exposed portion of the backing sheet 30 are substantially non-adhesive, and not sticky or tacky to the touch.

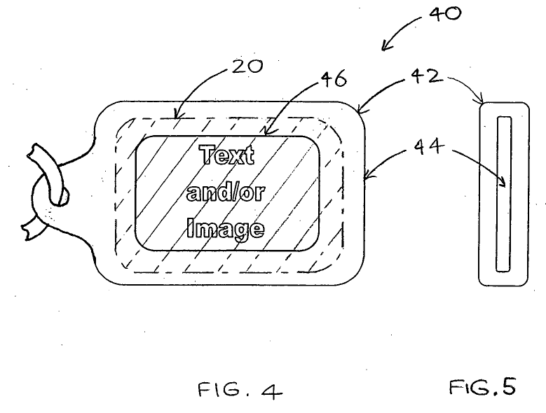

FIGS. 4 and 5 show a customised item according to an embodiment of the present invention. In the embodiment illustrated the customised item is a key fob 40. The body 42 of the key fob 40 has a pocket 44 for receiving a removable item 20, and a transparent viewing portion 46. When a removable item 20, acting as an insert element, is inserted into the pocket 44, all or part of the printed face of the removable item 20 is visible. Alternatively, the body 42 of the key fob 40 may have two viewing portions on opposite sides, and the pocket 44 may receive two removable elements 20 so that the printed faces of each are visible.

The removable element 20 may be secured within the pocket 44 by an interference fit, or by closing the open end of the pocket with a stopper or other lid, or by adhesive, clips or other means.

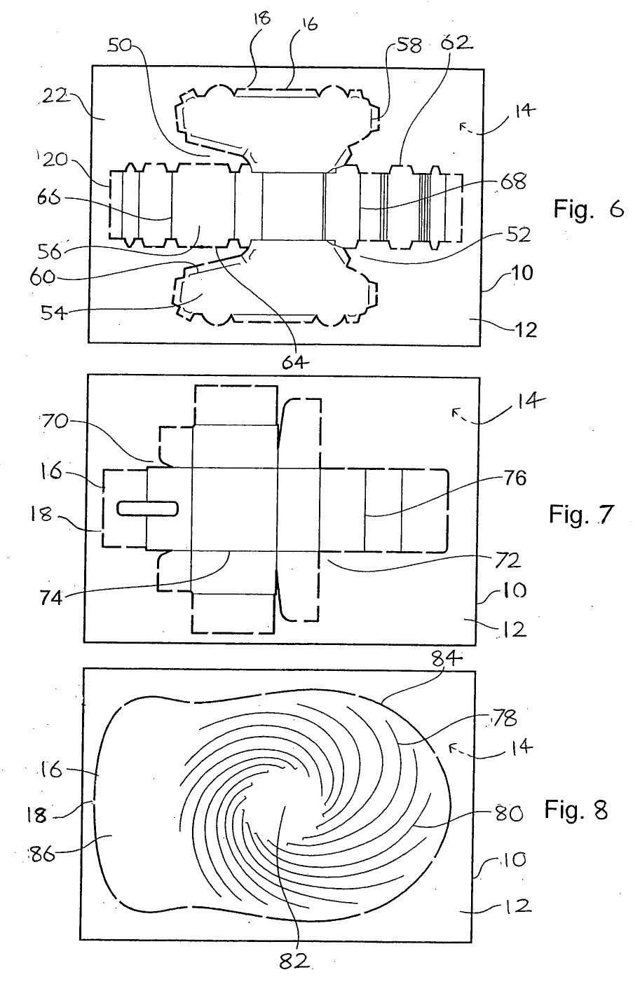

FIGS. 6 to 8 show embodiments wherein the removable element is in a shape such that, when removed from the waste element 22 and backing sheet 14, it can be formed into a three-dimensional article, such as a novelty item. Each embodiment includes a printable laminate 10 having a top sheet 12 laminated with a backing sheet 14. The printable laminates shown in these embodiments are formed in the same way as those shown in earlier embodiments, and may be printed in a similar fashion. Furthermore, in each of the embodiments shown, the perimeter of a removable element 20 is defined by an intermittent cut line 16 including a plurality of bridging portions 18. The intermittent cut line 16 and bridging portions 18 are formed as described in the previous embodiments, and perform the same function.

In the embodiment shown in FIG. 6, the shape of the removable element 20 includes concave cut features 50, 52. These concave cut features allow the different parts (e.g. side portion 54 and bonnet portion 56) of the removable element 20 to move relative to each other after removal from the backing sheet 14 and waste element 22.

Lines 58, 60 represent slots cut into the shape of the removable element 20. These slots are intended to receive tabs 62, 64, respectively.

Lines 66, 68 represent lines of weakness formed into the removable element. These are typically formed as scored lines or microperforations in a way known to the skilled person.

As will be clear, the removable element 20, once removed from the backing sheet 14 and waste element 22 by breakage of the bridging portions 18, may be folded into the three-dimensional form of a toy car. Prior to removal from the backing sheet 14 and waste element 22, however, the removable element 20 may be printed using a conventional printer to give appropriate car-like decoration.

FIG. 7 shows a simpler design than FIG. 6. In this case, the printable laminate has cut into its top sheet 12 a removable element 20 for folding into the shape of a container (here, a box). Concave cut features 70, 72 allow folding of the different sides of the container towards each other. Lines of weakness 74, 76, generated by scoring or by the forming of microperforations, permit this folding.

FIG. 8 the printable laminate has cut into its top sheet 12 a removable element 20 for forming into a novelty hat. Cut features 78, 80 are wholly contained within the perimeter of the shaped removable element. The cut features are arranged in a spiral pattern. On removal of the removable element 20 from the backing sheet 14 and waste element 22, the cut features allow the flat form of the shaped element to form into the three-dimensional form, or body form, (a hat shape) by opening up of the cut features. In this way, the central hub portion 82 of the hat is able to move out of plane with the rim portion 84 so as to define a space to receive the wearer's head. Peak portion 86 remains substantially in-plane with the rim portion 84.

Again, the hat of FIG. 8 may be printed before removal from the backing sheet.

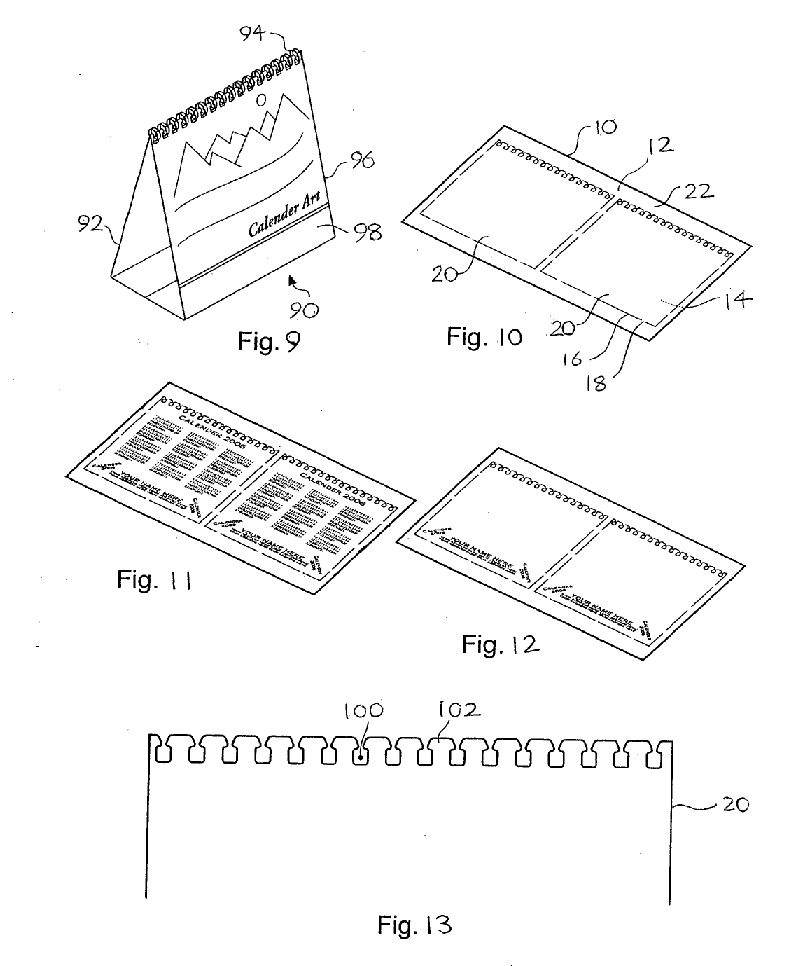

FIGS. 9 to 13 show embodiments wherein the removable element is in a shape such that, when removed from the waste element 22 and backing sheet 14, it can be inserted into a stationery article, such as a desktop calendar. Each embodiment includes a printable laminate 10 having a top sheet 12 laminated with a backing sheet 14. The printable laminates shown in these embodiments are formed in the same way as those shown in earlier embodiments, and may be printed in a similar fashion. Furthermore, in each of the embodiments shown, the perimeter of a removable element 20 is defined by an intermittent cut line 16 including a plurality of bridging portions 18. The intermittent cut line 16 and bridging portions 18 are formed as described in the previous embodiments, and perform the same function.

FIG. 9 shows the general form of a desktop calendar 90 of the type that is known. The calendar has a cardboard fold-out easel 92, the two ends of the easel meeting at the apex of the calendar, where they are bound together by a wire comb binding 94. The wire binding 94 extends through holes (not shown) in the cardboard in a known fashion. Also included in the calendar binding are calendar sheets 96. Typically, there will be twelve such sheets, each displaying information relating to one month of the year. Optionally, there is an additional cover sheet. Each of the calendar sheets has holes (not shown) for the wire binding 94 to extend through, in a similar way to the cardboard easel.

The holes in the calendar sheets and in the easel for the wire binding are closed. This provides more secure fixing of the sheets and easel with the binding.

The mass production of calendars such as that shown in FIG. 9 requires that the calendar sheets are printed, arranged and then punched to give the holes. Optionally, the easel may be punched in the same operation. Then, the binding is inserted to bind the sheets together in the calendar. It is not practicable to carry out short production runs for a small number (e.g. tens or hundreds, or even one) of bespoke printed calendars.

It is preferred instead to personalise a standard calendar with a personalisation sheet. The personalisation sheet might contain, for example, business details (in the case of a small business sending calendars to its customers) or it might contain a personal message for the recipient.

It will be noted that the length of the inclined face of the easel is greater than that of the calendar sheets in the calendar of FIG. 9. Thus, there is a gap 98 at the base of the calendar sheets.

A blank printable laminate with removable elements suitable for the calendar of FIG. 9 is shown in FIG. 10. Printed versions of the same printable laminate are shown in FIGS. 11 and 12. The printable laminate consists of removable elements 20 and a waste element 22 formed in the top sheet 12, and a backing sheet 14.

The shape cut into the top sheet of the printable insert is relatively complex. The complex part is shown in FIG. 13, which shows an enlarged portion of one side of one of the removable elements 20, after peeling from the backing sheet 14. As can be seen in FIG. 13, a series of open apertures 100 is formed at one side of the removable element 20. The open apertures 100 are separated by barbs 102. It is possible to insert the removable element into the binding 94 of the calendar by pushing the barbed portions 102 between the wire binding elements of the binding 94 using a tool (not shown) having teeth spaced at the same pitch as the barbed elements, pressing on the barb elements. Once inserted, the barb elements spring back (at least partially) to hold the wire binding elements in place in the apertures 100.

As in previous embodiments, the removable elements 20 may be printed before removal from the backing sheet 14 and waste element 22 by breakage of the bridging portions 18. In this embodiment, bridging portions are not provided at the cut line defining the open apertures 100 and barbs 102. After removal from the backing sheet and waste element, each removable element 20 may then be inserted into a desktop calendar as described above, to give a personalised calendar. As shown in FIGS. 11 and 12, the personalisation information is printed towards the base of the removable elements 20. Thus, once inserted into the calendar binding, this information will be visible at space 98 of the calendar.

It is noted that, usually, such stationery articles will require the removable elements to be located at the front of the article, optionally under a cover through which the insert is visible.

Modifications of the present embodiments, further embodiments and modifications thereof will be apparent to the skilled person on reading this disclosure, and as such these are within the scope of the present invention. In particular, it is possible that means other than tabs and slots (as described with reference to FIG. 6) may be used to hold the removable element in a three-dimensional, or body, form. For example, press studs or other connectors may be provided (e.g. as part of a kit) to attach parts together or to provide anchor points for other connectors such as elastic fasteners. Additionally, in relation to insertion elements for stationery articles, it may be possible to locate one or more insertion element within an article, and at any position within that article.

Furthermore, it will be understood that the present invention is not limited in application to the embodiments shown, but may be applied to any customisable item such as, for example, a key fob, drinks coaster, name tag, ruler, pen, mouse mat, table mat, clock, letter opener, memo holder, pen pot, badge, paper stand, drinks container such as a travel mug, fridge magnet and calendar case; or to any novelty item such as, for example, a mask, or toy; or to any stationery item such as, for example, a ticket, diary or notebook.

1. A printable laminate comprising a top sheet laminated with, and adhered to, a face of a backing sheet, the top sheet being printable and having a removable element and a waste element, said removable element and waste element being divided by an intermittent cut line extending between said waste element and said removable element, the intermittent cut line having a plurality of bridging portions connecting said removable element and waste element, the removable element being separable from the backing sheet and waste element by breakage of the bridging portions wherein, when the removable element is separated from the backing sheet, the removable element is substantially non-adhesive.

2. A printable laminate according to claim 1, wherein the top sheet has a density of at least 80 gsm.

3. A printable laminate according to claim 1, wherein the top sheet has a density of at least 120 gsm.

4. A printable laminate according to claim 1, wherein each bridging portion has a width of 1 mm or less.

5. A printable laminate according to claim 1, wherein the bridging portions are spaced apart on said cut line by 15 mm or less, on average for said cut line.

6. A printable laminate according to claim 1, wherein, when the removable element is separated from the backing sheet, the exposed face of the backing sheet is substantially non-adhesive.

7. A printable laminate according to claim 1, wherein a plurality of removable elements are arrayed in a matrix in said top sheet.

8. A printable laminate according to claim 1, wherein the removable element is an insert element for insertion into a customisable item, the customisable item being selected from one of: a key fob, drinks coaster, name tag, ruler, pen, mouse mat, table mat, clock, letter opener, memo holder, pen pot, badge, paper stand, drinks container such as a travel mug, fridge magnet and calendar case

9. A printable laminate according to claim 1, wherein the waste element abuts against the removable element at its perimeter.

10. A printable laminate according to claim 1, wherein the or each removable element is in a flat form when laminated with the backing sheet and being formable into a predetermined body form after removal from the backing sheet and waste element, and has at least one concave or inward cut feature at its perimeter or a cut feature wholly or partly disposed within its perimeter, said cut feature defining first and second cut surfaces that move relative to each other to accommodate the shape change from the flat form to the body form.

11. A printable laminate according to claim 10, wherein the body form has concave or convex cross-sections in each of two or more orthogonal directions.

12. A printable laminate according to claim 10 wherein the at least one cut feature forms all or part of a cut pattern in the removable element and the cut pattern opens to accommodate the shape change from the flat form to the body form.

13. A printable laminate according to claim 10 wherein the cut feature is at least one slit that is closed in the flat form and open in the body form.

14. A printable laminate according to claim 10 wherein the cut feature is a pattern of spiral slits interposed between a central portion and a rim portion, the central portion being moveable out of plane from the rim portion by opening of the spiral slits.

15. A printable laminate according to claim 10 wherein the removable element includes attachment formations that cooperate to attach to each other in the body form to retain the removable element in the body form.

16. A printable laminate according to claim 10 wherein the body form of the article is selected from one of: a hat, a cap, a bib, a mask and a children's party product.

17. A printable laminate according to claim 10, wherein the removable element is formable into a predetermined container form having a base and walls, opposing walls being spaced apart from each other.

18. A printable laminate according to claim 10 wherein each removable element is foldable along scored or perforated lines.

19. A printable laminate according to claim 1, wherein the removable element has a shape to allow it, once removed from the backing sheet and the waste element, to be inserted into the binding of an article of stationery having a plurality of pages bound by a binding that extends through apertures in the pages, the apertures being guided around the binding when the pages are turned.

20. A printable laminate according to claim 19, wherein the removable element includes open apertures for allowing the removable element to be inserted into the binding.

21. A printable laminate according to claim 20, wherein the open apertures have fingers extending between them, the fingers being for insertion between elements of the binding.

22. A printable laminate according to claim 20 wherein the fingers have barbs formed at their free ends for retaining the removable element in the binding.

23. A printable laminate according to claim 20 wherein the open apertures are separated from the removable element by a cut line that does not include bridging portions.

24. A printable laminate according to claim 19, wherein the article of stationery is selected from one of: a calendar, a notebook, and a diary.

25. A kit including one or more printable laminates, the printable laminate comprising a top sheet laminated with, and adhered to, a face of a backing sheet, the top sheet being printable and having a removable element and a waste element, said removable element and waste element being divided by an intermittent cut line extending between said waste element and said removable element, the intermittent cut line having a plurality of bridging portions connecting said removable element and waste element, the removable element being separable from the backing sheet and waste element by breakage of the bridging portions wherein, when the removable element is separated from the backing sheet, the removable element is substantially non-adhesive, the kit further including instructions for printing onto the top sheet of the printable laminate before removal of the removable element from the backing sheet and waste element.

26. A kit including a customisable item having a pocket for receiving a removable element, and a printable laminate, the printable laminate comprising a top sheet laminated with, and adhered to, a face of a backing sheet, the top sheet being printable and having a removable element and a waste element, said removable element and waste element being divided by an intermittent cut line extending between said waste element and said removable element, the intermittent cut line having a plurality of bridging portions connecting said removable element and waste element, the removable element being separable from the backing sheet and waste element by breakage of the bridging portions wherein, when the removable element is separated from the backing sheet, the removable element is substantially non-adhesive, wherein each removable element is insertable into the pocket of the customisable item to customise said item.

27. A kit including an article of stationery having a plurality of pages bound by a binding that extends through apertures in the pages, the apertures being guided around the binding when the pages are turned, and a printable laminate, the printable laminate comprising a top sheet laminated with, and adhered to, a face of a backing sheet, the top sheet being printable and having a removable element and a waste element, said removable element and waste element being divided by an intermittent cut line extending between said waste element and said removable element, the intermittent cut line having a plurality of bridging portions connecting said removable element and waste element, the removable element being separable from the backing sheet and waste element by breakage of the bridging portions wherein, when the removable element is separated from the backing sheet, the removable element is substantially non-adhesive, wherein the removable element of the printable laminate is for insertion into the binding of said article after binding of said pages.

28. A kit according to claim 25 wherein the binding includes looped binding elements extending through the apertures.

29. A kit according to claim 25 wherein the apertures in the pages of the article of stationery are closed holes.

30. A kit according to claim 25 further including an insertion tool having a shape corresponding to spaces between elements of the binding.
